(19) United States
(12) Patent Application Publication
(10) Pub. No.: US 2007/0245223 A1
(43) Pub. Date: Oct. 18, 2007

(54) Synchronizing multimedia mobile notes

(75) Inventors: David J. Siedzik, Seattle, WA (US); Erin M. Riley, Seattle, WA (US); Joshua M. Pollock, Seattle, WA (US); Nithya Ramkumar, Redmond, WA (US); Santos Cordon, Seattle, WA (US); Sathia P. Thirumal, Bothell, WA (US); Shaheeda P. Nizar, Redmond, WA (US); Miko Arnab Sakhya Singha Bose, Seattle, WA (US); Joel Downer, Woodinville, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/405,251

(22) Filed: Apr. 17, 2006

(51) Int. Cl. G06F 17/00; G06F 15/16

(52) U.S. Cl. 715/500.1; 715/512; 709/205; 715/500; 709/227

(57) ABSTRACT

A software-based mechanism for taking multimedia notes while using a mobile computing device and synchronizing with a desktop note taking application is provided. A note document containing textual data and objects representing other data types may be synchronized in whole or in part between the two applications. The documents including file formatting of the non-text data may be converted to a preferred format during synchronization.

### BACKGROUND

Small, handheld computing devices have been steadily growing in popularity in recent years. The devices are known by different names, such as pocket computers, personal digital assistants, personal organizers, H/PCs, or the like. Additionally, many portable telephone systems, such as cellular phones, incorporate sufficient computing capabilities to fall within the category of the small, handheld computing devices. These devices, hereinafter “mobile computing devices” provide much of the same functionality as their larger counterparts. In particular, mobile computing devices provide many functions to users including word processing, task management, spreadsheet processing, address book functions, Internet browsing, and calendaring, as well as many other functions.

Many mobile computing devices include on-board cameras and/or audio recorders. Accordingly, users can record, download, access multimedia files, create ink entries and other types of documents. It is a challenge, however, for the users to collect a variety of images, audio files, text data, and the like, into a single context, especially one that is suitable for use on a personal computer in a productivity environment. Typically, some applications enable a user to annotate an audio or video file, or vice versa, but the original data is in most cases handled in its environment without a seamless combination with other types of data.

A further challenge for users of mobile computing devices is extending the capability of their devices to collect various types of data to a desktop application or vice versa.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Aspects are directed to providing a unified environment for different data types in a mobile computing device. Non-text data may be received from on-board resources or from a file. A document may be created and objects corresponding to non-text data inserted with annotations in textual data.

Documents and their contents (i.e. textual data and objects corresponding to non-text data) may be synchronized with documents on other platforms by reformatting textual data, non-text data files, and the like.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a diagram of an example mobile computing device;

FIG. 2 is a block diagram illustrating components of a mobile computing device used in one embodiment, such as the computer shown in FIG. 1;

FIG. 3 illustrates a networked environment where embodiments may be practiced;

FIG. 4 is a block diagram illustrating a software environment according to one embodiment;

FIG. 5 is a conceptual diagram illustrating a note document along with interactions of included objects with their respective resources according to embodiments;

FIG. 6 illustrates a logic flow diagram for a process of providing a unified experience for capturing dynamic information in a mobile computing device; and

FIG. 7 is a conceptual diagram illustrating synchronization of note documents and their contents between a mobile computing device and a desktop computing device.

### DETAILED DESCRIPTION

As briefly described above, embodiments are directed to combining different data types into a unified experience for capturing dynamic information that is suitable for use on a small form-factor, mobile computing device.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

As used herein, the term “note” refers to a document that includes a collection of textual data such as rich text and objects. An object represents content and relative position of non-text data.

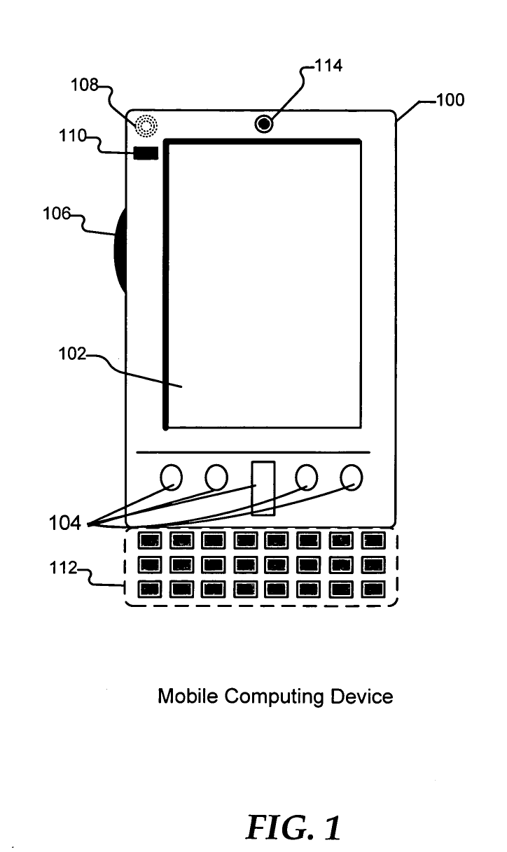

Referring now to the drawings, aspects and an example operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, an example mobile computing device 100 for implementing the embodiments is illustrated. In a basic configuration, mobile computing device 100 is a handheld computer having both input elements and output elements. Input elements may include touch screen display 102 and input buttons 104 and allow the user to enter information into mobile computing device 100. Mobile computing device 100 also incorporates a side input element 106 allowing further user input. Side input element 106 may be a rotary switch, a button, or any other type of manual input element. In alternative embodiments, mobile computing device 100 may incorporate more or less input elements. For example, display 102 may not be a touch screen in some embodiments. In yet another alternative embodiment, the mobile computing device is a portable phone system, such as a cellular phone having display 102 and input buttons 104. Mobile computing device 100 may also include an optional keypad 112. Optional keypad 112 may be a physical keypad or a “soft” keypad generated on the touch screen display. Yet another input device that may be integrated to mobile computing device 100 is on-board camera 114.

Mobile computing device 100 incorporates output elements, such as display 102, which can display a graphical user interface (GUI). Other output elements include speaker 108 and LED light 110. Additionally, mobile computing device 100 may incorporate a vibration module (not shown), which causes mobile computing device 100 to vibrate to notify the user of an event. In yet another embodiment, mobile computing device 100 may incorporate a headphone jack (not shown) for providing another means of providing output signals.

Although described herein in combination with mobile computing device 100, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment, programs may be located in both local and remote memory storage devices. To summarize, any computer system having a plurality of environment sensors, a plurality of output elements to provide notifications to a user and a plurality of notification event types may incorporate embodiments of the present invention.

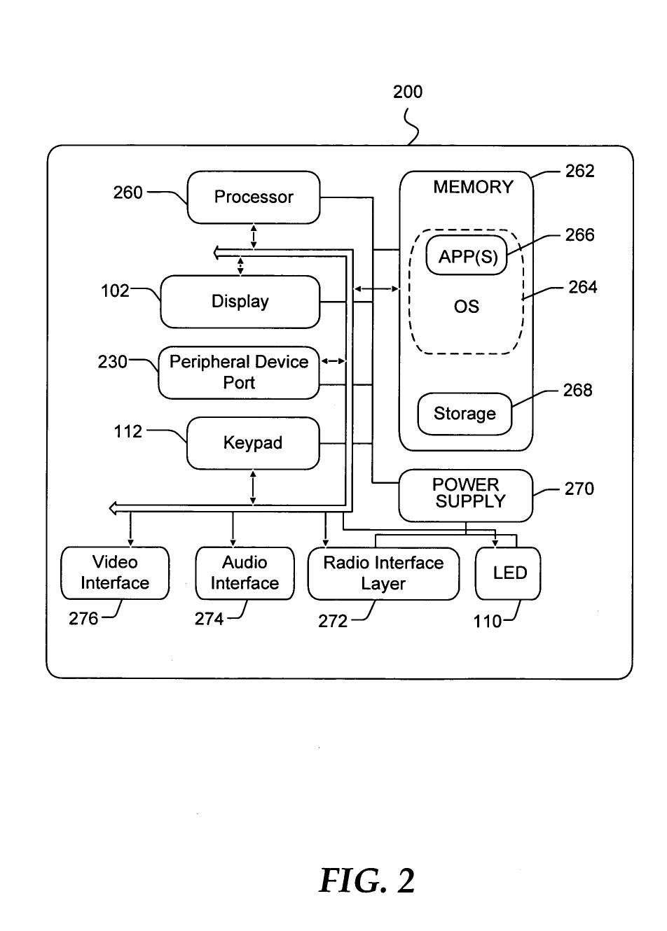

FIG. 2 is a block diagram illustrating components of a mobile computing device used in one embodiment, such as the computing device shown in FIG. 1. That is, mobile computing device 100 (FIG. 1) can incorporate system 200 to implement some embodiments. For example, system 200 can be used in implementing a “smart phone” that can run one or more applications similar to those of a desktop or notebook computer such as, for example, browser, email, scheduling, instant messaging, and media player applications. System 200 can execute an Operating System (OS) such as, WINDOWS XP®, WINDOWS MOBILE 2003® or WINDOWS CE® available from MICROSOFT CORPORATION, REDMOND, Wash. In some embodiments, system 200 is integrated as a computing device, such as an integrated personal digital assistant (PDA) and wireless phone.

In this embodiment, system 200 has a processor 260, a memory 262, display 102, and keypad 112. Memory 262 generally includes both volatile memory (e.g., RAM) and non-volatile memory (e.g., ROM, Flash Memory, or the like). System 200 includes an OS 264, which in this embodiment is resident in a flash memory portion of memory 262 and executes on processor 260. Keypad 112 may be a push button numeric dialing pad (such as on a typical telephone), a multi-key keyboard (such as a conventional keyboard), or may not be included in the mobile computing device in deference to a touch screen or stylus. Display 102 may be a liquid crystal display, or any other type of display commonly used in mobile computing devices. Display 102 may be touch-sensitive, and would then also act as an input device.

One or more application programs 266 are loaded into memory 262 and run on or outside of operating system 264. Examples of application programs include phone dialer programs, e-mail programs, PIM (personal information management) programs, word processing programs, spreadsheet programs, Internet browser programs, and so forth. System 200 also includes non-volatile storage 268 within memory 262. Non-volatile storage 268 may be used to store persistent information that should not be lost if system 200 is powered down. Applications 266 may use and store information in non-volatile storage 268, such as e-mail or other messages used by an e-mail application, contact information used by a PIM, documents used by a word processing application, and the like. A synchronization application (not shown) also resides on system 200 and is programmed to interact with a corresponding synchronization application resident on a host computer to keep the information stored in non-volatile storage 268 synchronized with corresponding information stored at the host computer. In some embodiments, non-volatile storage 268 includes the aforementioned flash memory in which the OS (and possibly other software) is stored.

System 200 has a power supply 270, which may be implemented as one or more batteries. Power supply 270 might further include an external power source, such as an AC adapter or a powered docking cradle that supplements or recharges the batteries.

System 200 may also include a radio 272 that performs the function of transmitting and receiving radio frequency communications. Radio 272 facilitates wireless connectivity between system 200 and the “outside world”, via a communications carrier or service provider. Transmissions to and from radio 272 are conducted under control of OS 264. In other words, communications received by radio 272 may be disseminated to application programs 266 via OS 264, and vice versa.

Radio 272 allows system 200 to communicate with other computing devices, such as over a network. Radio 272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 200 is shown with two types of notification output devices: LED 110 that can be used to provide visual notifications and an audio interface 274 that can be used with speaker 108 (FIG. 1) to provide audio notifications. These devices may be directly coupled to power supply 270 so that when activated, they remain on for a duration dictated by the notification mechanism even though processor 260 and other components might shut down to conserve battery power. LED 110 may be programmed to remain on indefinitely until the user takes action to indicate the powered-on status of the device. Audio interface 274 is used to provide audible signals to and receive audible signals from the user. For example, in addition to being coupled to speaker 108, audio interface 274 may also be coupled to a microphone to receive audible input, such as to facilitate a telephone conversation. In accordance with embodiments of the present invention, the microphone may also serve as an audio sensor to facilitate control of notifications, as will be described below.

System 200 may further include video interface 276 that enables an operation of on-board camera 114 (FIG. 1) to record still images, video stream, and the like. According to some embodiments, different data types received through one of the input devices, such as audio, video, still image, ink entry, and the like, may be integrated in a unified environment along with textual data by applications 266. Further details of how this may be accomplished is described below.

A mobile computing device implementing system 200 may have additional features or functionality. For example, the device may also include additional data storage devices (removable and/or non-removable) such as, magnetic disks, optical disks, or tape. Such additional storage is illustrated in FIG. 2 by storage 268. Computer storage media may include volatile and nonvolatile, removable and non-removable media implemented in any method or technology for storage of information, such as computer readable instructions, data structures, program modules, or other data.

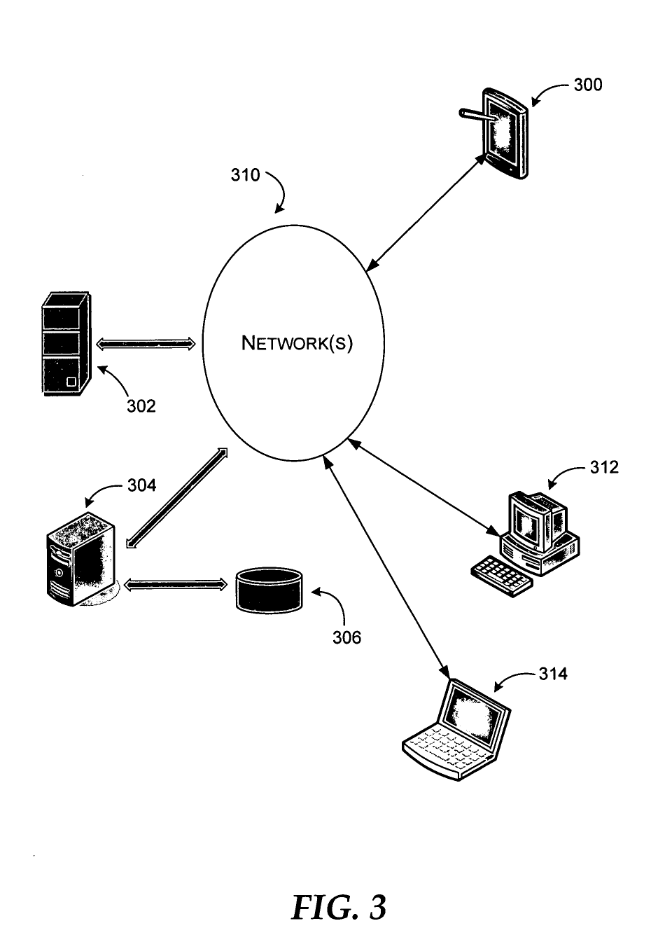

Referring to FIG. 3 now, a networked system is illustrated where example embodiments may be implemented. Various data types may be created and/or processed in a mobile computing device such as mobile computing device 100 of FIG. 1. Examples of different data types include images, video, audio, and ink entry that may be created using one of the input devices of the mobile computing device or any one of the same data types that may be opened from an existing file. According to some embodiments, a mechanism for integrating different data types in a single document along with textual data is provided. An application performing necessary actions to create, modify, and present such a unified document may be executed in mobile computing device 300.

Mobile computing device 300 may operate in a networked environment transmitting and receiving data to and from other computing devices such as server 302, desktop computer 312, and laptop computer 314. Exchanged data may include any of the types described above. Furthermore, mobile computing device 300 may transmit or receive data to a storage system 306, which is managed by server 304. Other computing devices known in the art may participate in this networked system as well. The application creating and processing the unified document(s) may be restricted to mobile computing device 300 or executed in a distributed manner by a number of computing devices participating in the networked environment.

The computing devices participating in the networked environment may communicate over network(s) 310. Network(s) 310 may include one or more networks. The network(s) 310 may include a secure network such as an enterprise network, or an unsecure network such as a wireless open network. By way of example, and not limitation, the network(s) may include wired media such as a wired network or direct-wired connection, and wireless media such as acoustic, RF, infrared and other wireless media.

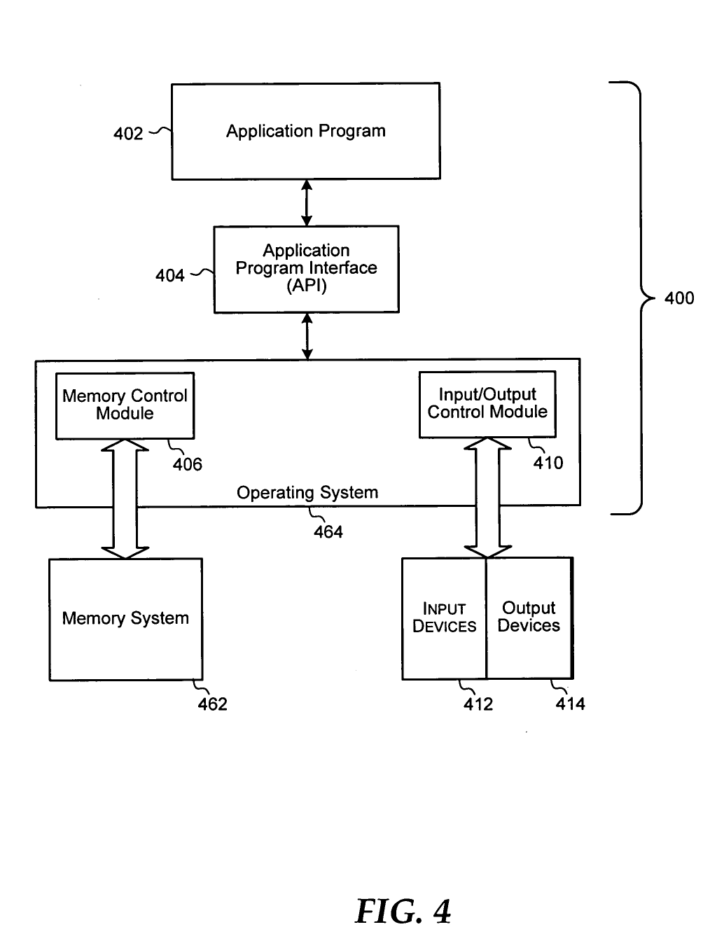

Now referring to FIG. 4, a block diagram illustrating a software environment according to one embodiment is shown. Several scenarios may be described to illustrate the advantages of an application that can provide a unified environment for different data types in a mobile computing device. For example, a user may capture images and/or audio recordings during a meeting and combine those into a single document with textual annotations. According to another scenario, a task list may be generated using images combined with ink entries that were made earlier with annotations for each entry. In both scenarios, the user may desire to modify the unified document repeatedly, for example updating the task list as tasks are being accomplished.

These scenarios are not intended to be limiting; rather, they are intended to illustrate the flexibility of a multimedia note taking application in handling different data types and information obtained from the software environment of the mobile computing device.

According to embodiments, application program 302 is configured to generate a document (also called “note” herein) that includes textual data along with objects that are aligned with the textual data. The textual data may be rich text, allowing formatting of the text, creation of bulleted or numbered lists, insertion of hyperlinks and the like. Aligning the objects with the text allows users to handle the note even on a mobile computing device that does not include touch screen capability.

The objects are placeholders for different types of data captured or received by the mobile computing device. According to one embodiment, following data types may be combined in a document in a unified manner:
Images (from either the device's on-board camera or from an image file)
Audio (recorded from the device's microphone or from an audio file)
Video (from either the device's on-board camera or from a video file)
Textual annotations
Lists
Tables
Ink entries

Application program 402 can communicate with operating system 464 through an application program interface (API) 406. Application program 402 can make calls to methods of API 406 to request OS 464 to activate applications specific to each data type. For example, an audio player program may be activated by the OS 464 when called by application program 402. Furthermore, OS 464 may communicate with application program 402 to provide data from other applications such as video stream, ink entry, and the like. In alternative embodiments, the application program 402 communicates directly with OS 464.

Application program 402 also communicates with a user through OS 464, input/output control module 410 and input/output devices 412 and 414. Input devices 412 can include an on-board camera, a microphone, an inking canvas, and the like, such as described above. In this embodiment, application program 402 receives input signals to generate respective objects and insert them into the note providing the unified environment. The data associated with each object, as well as the note itself, may be stored by application program 402 in memory system 462 through OS 464 and through a memory control module 406.

Although the above-described embodiment has been described in terms of separate modules or components, in other embodiments the functions of the various modules or components may be performed by other modules and/or combined into fewer modules. In still other embodiments, some of the functions performed by the described modules may be separated further into more modules.

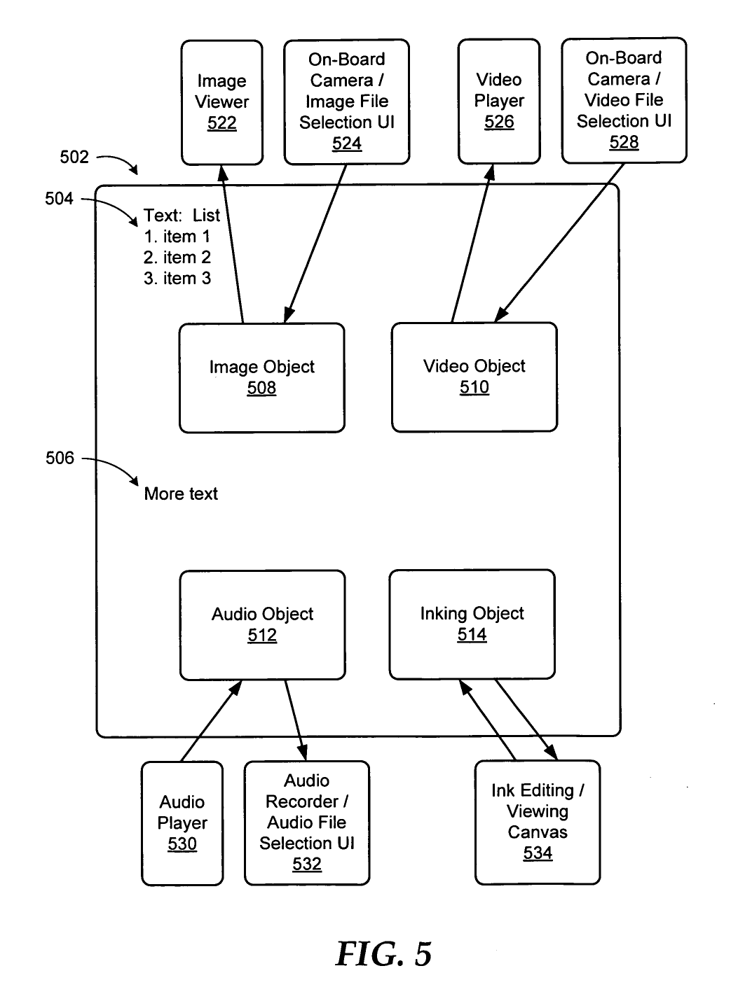

FIG. 5 is a conceptual diagram illustrating a note document along with interactions of included objects with their respective resources according to embodiments. Note 502 represents a document that is created by an application like application program 402 of FIG. 4 to provide a unified environment for different data types in a mobile computing device. Note 502 may have textual data entries in various locations of the document such as text 504, which is a numbered list, and more text 506. Depending on user actions, objects can be inserted in note 502. Image object 508, video object 510, audio object 512, and inking object 514 are representative of objects corresponding to different data types. Data types are not limited to the example ones provided herein. Other data types may also be managed by a multimedia note taking application according to embodiments.

Each object may be created and viewed employing a set of native applications (or the same application). In another embodiment, the multimedia note taking application may include a viewer (or player) module that lets users access the data without having to activate another application. Image object 508 may be used to include still image data in the note such as pictures, graphics, icons, and the like. Data represented by image object 508 may be created by on-board camera or image file selection UI 524. The image may be viewed using image viewer 522.

According to one embodiment, an integrated viewer application may provide additional mobile device specific functionality that enhances user experience. For example, the integrated viewer may divide a picture into grid zones and assign a key from the keypad of the mobile computing device to each grid zone. Then, a grid zone may be displayed in zoom mode, if the user presses the corresponding key. This approach is faster and simpler for the user than commonly used zoom to a selected point (e.g. center of the image) and pan in the direction of the zone of interest on the image.

Video object 510 operates in a similar fashion to the image object 508. Video object 510 represents a video stream created by on-board camera or image file selection UI 528 and viewed by video player 526, which may again be a separate application or an integrated module of the note taking application.

Audio object 512 represents audio files recorded by audio recorder (using on-board microphone) or audio file selection UI 532. An audio player, as described above, may be utilized to listen to the audio files.

Inking object 514 represents inking entries provided by a touch screen type hand writing or drawing application. Other types of entry methods such as charge couple pads may also be used to provide the inking entry. An ink editing/viewing canvas 534 may be used to view and or edit the inking entry.

As mentioned before, not all mobile computing devices include a stylus type input device. For mobile computing devices with keypad input only (such as smart phones), objects may be displayed in a selectable fashion on the device UI. For example, a highlighting mechanism such as a rectangle around the object may be moved around based on keystrokes such that any one of the objects can be selected for further actions. Once the object is selected, the user may be provided with options such as viewing/listening to the associated data, editing, moving the object to another location, and the like.

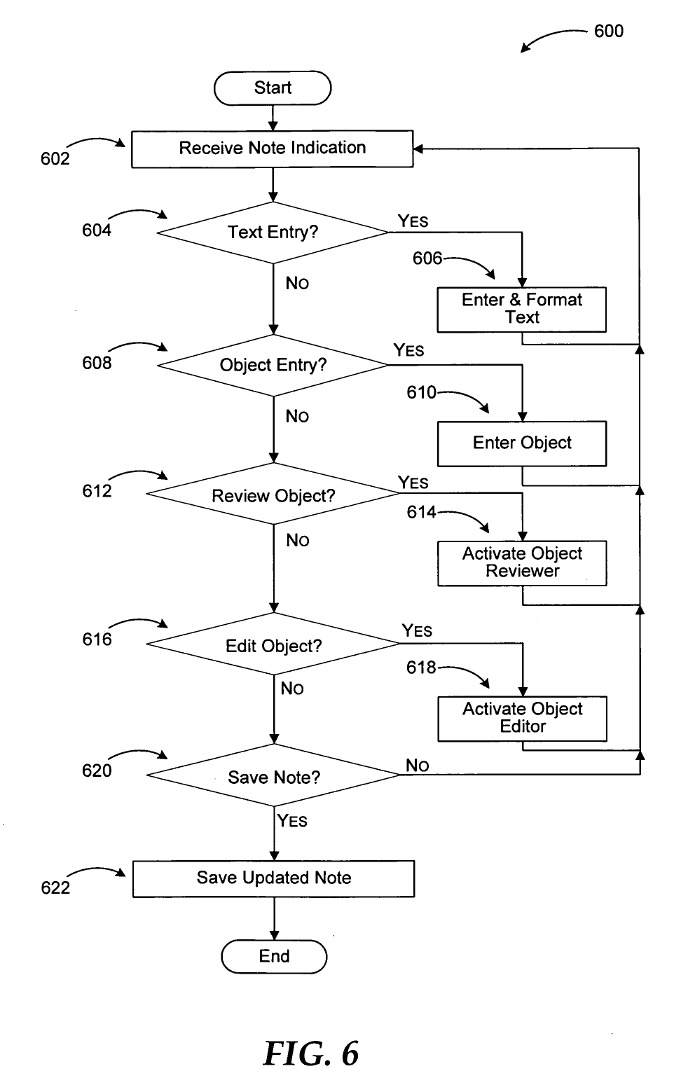

FIG. 6 illustrates a logic flow diagram for a process 600 of providing a unified experience for capturing dynamic information in a mobile computing device. Process 600 may be implemented in a mobile computing device as described in FIGS. 1 and 2.

Process 600 begins with operation 602, where an indication is received to initiate a note. The indication may be recording of data associated with an object such as taking of a picture, recording of an audio file, and the like. The indication may also be a direct activation of the multimedia note taking application. Processing moves from operation 602 to decision operation 604.

At decision operation 604, a determination is made whether a text entry is requested. A user may wish to begin a note by typing in text such as a list. If a text entry is to be made, processing moves to operation 606. Otherwise, processing continues to decision operation 608.

At operation 606, text entry by the user is placed in the note and formatted. Processing then returns to operation 602. At decision operation 608, a determination is made whether an object is to be inserted into the note. If the note indication was recording of data associated with an object, the object may be entered automatically. On the other hand, a user may desire to insert a new object in an already open note. If an object is to be inserted, processing moves to operation 610.

At operation 610, the object is inserted. Along with inserting a graphic icon of the object, the application may also initiate a native application or an integral module for inserting the data associated with the object. This may include, for example, activating an on-board camera, starting audio recording, activating a UI for a video file selection, and the like. Processing returns from operation 610 to operation 602.

If no object is to be inserted at decision operation 608, processing advances to decision operation 612 where a determination is made whether an object is to be reviewed. An existing note may include one or more objects corresponding to different data types. If the user indicates a desire to review one of those objects, processing moves to operation 614. Otherwise, processing continues to decision operation 616.

At operation 614, an object reviewer is activated. Similar to creating the data at operation 610, a separate application or an integrated module may be employed to review the data associated with the object (e.g. audio player, video player, inking canvas, and the like). Processing returns to operation 602 from operation 614.

At decision operation 616, a determination is made whether an object is to be edited. If an object is to be edited, processing moves to operation 618. At operation 618, an object editor is activated similar to the reviewing operations. Processing then returns to operation 602.

If no object is to be edited at decision operation 616, processing advances to decision operation 620. At decision operation 620, a determination is made whether the note is to be saved. If the note is to be saved, processing moves to operation 622. Otherwise processing returns to operation 602.

At operation 622, the update note is saved. A note may be edited repeatedly by the user allowing insertion, removal, and editing of objects, as well as editing of the textual data within the note. After operation 622, processing moves to a calling process for further actions.

The operations included in process 600 are for illustration purposes. Providing a unified experience for capturing dynamic information in a mobile computing device may be implemented by similar processes with fewer or additional steps, as well as in different order of operations using the principles described herein.

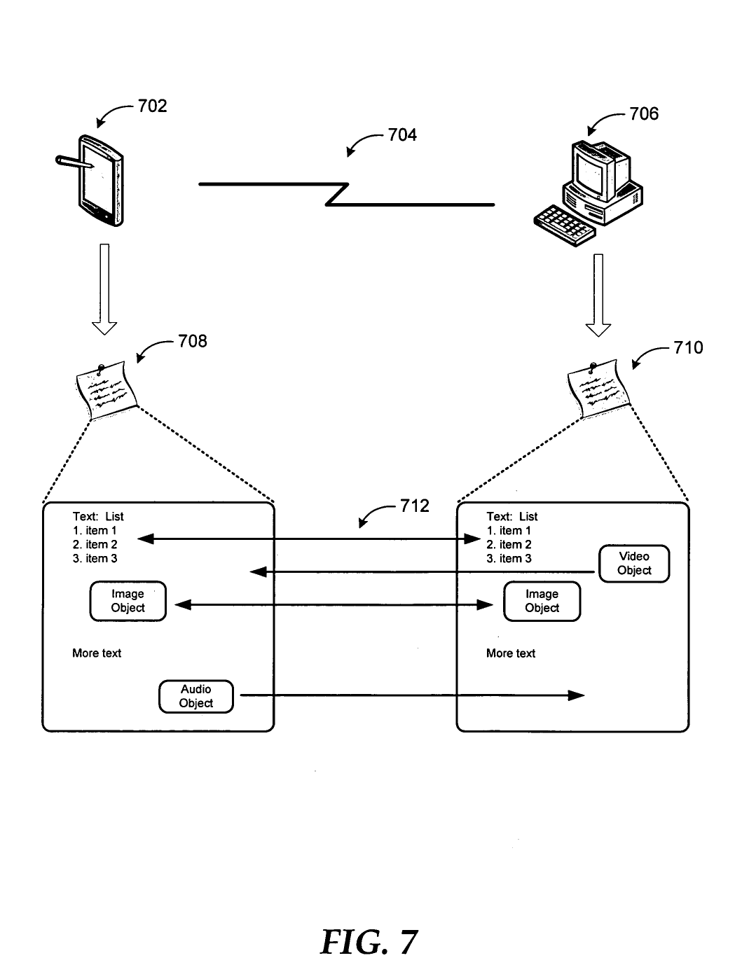

Now referring to FIG. 7, a conceptual diagram illustrating synchronization of note documents and their contents between a mobile computing device and a desktop computing device is shown. Some programs allow taking notes on a desktop application with links to other data types. An example for such a program is ONENOTE® available from MICROSOFT CORPORATION, REDMOND, Wash. Typically, such programs do not provide the capability to insert non-text data directly from an on-board source such as a picture taken by an on-board camera, however.

On the other hand, scenarios where two applications, a desktop note taking application and a mobile note taking application, can work in concert may arise. For example, a sales person going on a customer call may prepare notes for his/her meeting on a desktop application inserting customer information, list of items to be discussed, maybe even a picture of the customer for easy identification. Instead of carrying around a laptop computer, the sales person may desire to download the prepared note to their mobile device (e.g. cellular phone). During the meeting they may end up adding a few more notes or taking one or more pictures using their phone. Then, back at the office, they may wish to integrate all of the information in their desktop application. Thus, a seamless transition and synchronization between the desktop note taking application and the mobile computing device application may provide them a comprehensive productivity environment.

Mobile computing device 702 in FIG. 7 includes a multimedia note taking application as described above. Desktop computing device 706 includes a desktop note taking application. The two devices are in communication through medium 704. The communication may be wired or wireless (e.g. infrared, RF, serial, parallel, and the like).

Note 708 is an example document generated by the note taking application on the mobile computing device 702. It may include textual data and a number of objects corresponding to different types of non-text data. Similarly, note 710 is an example document generated by the note taking application on the desktop computing device 706. Note 710 may include same or different textual data and a number of other objects corresponding to different types of non-text data.

According to one embodiment, note 708 may be generated using rich text format to preserve formatting and similar properties of textual data. Note 710 may be generated using another format such as extensible Markup Language (XML). The data format of each note also determines how non-text data is incorporated into the document. For example, in one format, non-text data such as images may be integrated into the document in binary format, while in another format, the image may be preserved in its native format and a link established between the image file and the object in the note document.

During synchronization process 712, notes on either device may be transferred completely from one device to the other or they may be converted to the target device's preferred formatting. According to other embodiments, individual items such as objects within notes may be updated on either device. For example, a picture taken by the mobile computing device 702 may be saved in binary format within note 708. During the synchronization process 712, the picture data may be converted to an image format such as JPEG and inserted to the corresponding note 710 as a link.

The types of data, file formats, and synchronization types described above are for illustration purposes. Providing a unified environment for mobile productivity by synchronizing multimedia notes may be accomplished using types of data and formats other than those described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method to be executed at least in part in a computing device for multimedia note taking in a mobile computing device, comprising:
determining a corresponding pair of note documents in a mobile note taking application and in a desktop note taking application in response to a synchronization indication;
determining elements of each note document to be synchronized;
converting a format of each element for compatibility with a target note taking application; and
inserting the converted elements to the target note taking application.

2. The computer-implemented method of claim 1, wherein the synchronization indication includes one of: a user request and an establishment of communication between the mobile note taking application and the desktop note taking application.

3. The computer-implemented method of claim 2, wherein the synchronization indication is repeated periodically.

4. The computer-implemented method of claim 1, wherein the elements of each document include at least one of textual data and an object corresponding to non-text data.

5. The computer-implemented method of claim 4, wherein the textual data in the mobile note taking application is in rich text format.

6. The computer-implemented method of claim 4, wherein the non-text data includes at least one from a set of: audio data, video data, still image data, and inking entry data.

7. The computer-implemented method of claim 1, wherein converting the format for each element includes converting non-text data in native format to binary format and inserting into the note document for the mobile note taking application.

8. The computer-implemented method of claim 1, wherein converting the format for each element includes converting non-text data in binary format from the mobile note document to a preferred native format and inserting a link to the non-text data into the note document for the desktop note taking application.

9. The computer-implemented method of claim 8, wherein converting an image saved in binary format in the mobile note document includes converting the image to an image format, saving as a separate file, and inserting a link into the desktop note taking application for the saved image file.

10. The computer-implemented method of claim 1, further comprising dynamically reducing at least one formatting feature of a note document prepared by the desktop note taking application during conversion to a note document for the mobile note taking application.

11. The computer-implemented method of claim 1, further comprising dynamically removing at least one object of a note document prepared by the desktop note taking application during conversion to a note document for the mobile note taking application based on a capability of the mobile computing device.

12. The computer-implemented method of claim 1, further comprising moving a note document in whole to the target application, if there is no corresponding note document on a target computing device.

13. A system for providing a unified environment for capturing dynamic information suitable for use on a mobile computing device, the system comprising:
a mobile note taking application configured to:
generate a note document that combines textual data and non-text data represented by an object; and
enable inserting, reviewing, editing, and removing of the textual and non-text data associated with objects;
a desktop note taking application configured to:
generate another note document that combines textual data and non-text data represented by an object; and
enable inserting, reviewing, editing, and removing of the textual and non-text data associated with objects; and
a synchronization engine configured to:
synchronize note documents generated by the note taking applications by converting a format of at least one element of a note document on one note taking application and moving the element to a corresponding note document on the other note taking application.

14. The system of claim 13, wherein the synchronization engine is further configured to move a note document in whole to the target note taking application.

15. The system of claim 13, wherein the synchronization engine is further configured to determine a preferred format list for each non-text data type from the mobile note taking application and from the desktop note taking application.

16. The system of claim 13, wherein the synchronization engine is further configured to determine which elements to move based on a capability of a mobile computing device executing the mobile note taking application and a desktop computing device executing the desktop note taking application.

17. The system of claim 16, wherein the capability of the mobile computing device and the desktop computing device includes at least one from a set of: on-board resources, a memory capacity, a processing capacity, and a display capacity.

18. A computer-readable medium having computer executable instructions for synchronizing multimedia note taking between a mobile computing device and another computing device, the instructions comprising:
generating a first note document that combines textual data and non-text data represented by an object;
determining elements of the first note document to be synchronized with a second note document; and
synchronizing the first and second note documents by converting a format of at least one element of the first note document moving the converted element to the second note document.

19. The computer-readable medium of claim 18, wherein converting the format includes one of translating non-text data from a native format to a binary format and translating non-text data from the binary format to the native format.

20. The computer-readable medium of claim 18, wherein the non-text data includes at least one from a set of: image data, video data, audio data, and inking data.
